(19) United States
(12) Patent Application Publication
(10) Pub. No.: US 2026/0126162 A1
(43) Pub. Date: May 7, 2026

(54) LED LIGHTING DEVICE

(71) Applicant: Xiamen PVTECH Co., Ltd., Xiamen (CN)

(72) Inventors: FUXING LU, Xiamen (CN); RONGTU LIU, Xiamen (CN); HUIBAO LUO, Xiamen (CN); ZEHU DAI, Xiamen (CN); LIANGLIANG CAO, Xiamen (CN); CHUNMING LIU, Xiamen (CN); DEJIA LI, Xiamen (CN)

(21) Appl. No.: 19/441,905

(22) Filed: Jan. 7, 2026

Related U.S. Application Data
(63) Continuation-in-part of application No. 19/248,484, filed on Jun. 25, 2025.
Application No. 19/248,484 is a continuation-in-part of application No. 18/916,716, filed on Oct. 16, 2024, now Pat. No. 12,366,346.
Application No. 18/916,716 is a continuation-in-part of application No. 18/138,146, filed on Apr. 24, 2023, now Pat. No. 12,146,621.

(30) Foreign Application Priority Data
Jan. 7, 2025 (CN) 202510022931.X

(51) Int. Cl. F21V 3/10; F21Y 103/10; F21Y 115/10

(52) U.S. Cl. CPC F21V 3/10; F21Y 2103/10; F21Y 2115/10

(57) ABSTRACT

An LED lighting device includes a power supplier, a flexible board and a plurality of light sources. The flexible board is electrically connected to the power supplier, and includes a substrate and a laminated structure. The laminated structure is disposed on the first surface of the substrate and includes a transparent ink layer and a first protective layer. The transparent ink layer is disposed on the first protective layer. The light sources are disposed on the laminated structure and electrically connected to the flexible board.

### TECHNICAL FIELD

The disclosure relates to a lighting device, in particular to an LED lighting device.

### BACKGROUND

LED (light-emitting diode) light tubes have many advantages, such as high efficiency, low power consumption, long service life, etc., so LED light tubes have been comprehensively applied to various buildings. However, currently available LED light tubes still have many shortcomings to be overcome.

For example, the circuit board (printed circuit) of a currently available LED light tube has a protective layer (ink) for providing the insulating function and protecting the traces on the circuit board. However, the protective layer usually has a lot of openings and a plurality of LEDs are disposed in these openings respectively (for instance, U.S. Pat. No. 10,670,197 adopts the protective layer having the above design). Therefore, the coating process of the protective layer is very complicated and the halogen elements of the protective layer tend to move to the soldering sections of the circuit board. Accordingly, the soldering sections are prone to be oxidized, and the conductivity and the soldering effect thereof may be influenced during the manufacturing process.

The currently available LED light tubes do not have a proper optical structure design, so the overall light-emitting areas of these lighting devices are limited can be significantly increased. Therefore, the light efficiency of these LED lighting devices is low.

Further, the circuit board of a currently available LED light tube are typically adhered to the inner surfaces of the light cover thereof via an adhesive material. However, this method tends to generate stress that may damage the circuit board, potentially causing the light tube to malfunction. As a result, the service life of the light tube is also reduced.

Moreover, the traces of the adhesive material can affect the appearance of the light tube, compromising its overall aesthetics and negatively impacting the user experience. Moreover, the adhesive material may also affect the light efficacy of the light tube, resulting in a reduction in the overall performance of the light tube.

Furthermore, currently available flexible printed circuit boards (FPCBs) have poor arc resistance, which significantly limits their applications and prevents them from meeting actual requirements.

On the other hand, during the design of lighting devices (such as light tubes) that are compatible with electronic ballasts currently available on the market, it is necessary to place particular emphasis on evaluating safety under abnormal conditions occurring during operation of the electronic ballasts. Since most conventional lighting devices employ rigid printed circuit boards or flexible printed circuit boards as light source boards, and alternating current signals flow through the light source boards, the conductors (copper-clad traces) on these two types of circuit boards are prone to open circuits for various reasons or to spark generation due to scratching, which may ultimately lead to fire hazards. Accordingly, the safety of currently available circuit boards still requires improvement.

In order to address the above issues, some lighting devices adopt metal printed circuit boards with flame-retardant properties or double-sided metal flexible printed circuit boards. Although such circuit boards can mitigate the above problems to a certain extent, they also significantly increase the cost of the lighting devices.

### SUMMARY

One embodiment of the disclosure provides an LED lighting device, which includes a power supplier, a flexible board and a plurality of light sources. The flexible board is electrically connected to the power supplier, and includes a substrate and a laminated structure. The laminated structure is disposed on the first surface of the substrate and includes a transparent ink layer and a first protective layer. The transparent ink layer is disposed on the first protective layer. The light sources are disposed on the laminated structure and electrically connected to the flexible board.

In one embodiment, the first protective layer is an ink layer.

In one embodiment, the first protective layer is a cover film, and the cover film includes a bottom plate, a first adhesive layer, and an ink layer. The first adhesive layer is disposed on the bottom plate, and the ink layer is disposed on the first adhesive layer.

As set forth above, the flexible board has a multifunctional laminated structure. The transparent ink layer of the laminated structure can effectively enhance the arc resistance of the flexible board and can further improve the appearance of the flexible board. In addition, the first protective layer of the laminated structure can effectively increase reflectivity and can further enhance insulation performance and solder resist performance. Accordingly, by virtue of the laminated structure described above, the performance of the flexible board can be significantly improved so as to meet actual requirements.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is an exploded view of an LED lighting device in accordance with a first embodiment of the disclosure.

FIG. 2 is a perspective view of the LED lighting device in accordance with the first embodiment of the disclosure.

FIG. 3 is a first schematic view of a circuit board of the LED lighting device in accordance with the first embodiment of the disclosure.

FIG. 4 is a second schematic view of the circuit board of the LED lighting device in accordance with the first embodiment of the disclosure.

FIG. 5A is a third schematic view of the circuit board of the LED lighting device in accordance with the first embodiment of the disclosure.

FIG. 5B is a fourth schematic view of the circuit board of the LED lighting device in accordance with the first embodiment of the disclosure.

FIG. 6 is a first schematic view of a circuit board of the LED lighting device in accordance with a second embodiment of the disclosure.

FIG. 7 is a second schematic view of the circuit board of the LED lighting device in accordance with the second embodiment of the disclosure.

FIG. 8 is a third schematic view of the circuit board of the LED lighting device in accordance with the second embodiment of the disclosure.

FIG. 9 is a fourth schematic view of the circuit board of the LED lighting device in accordance with the second embodiment of the disclosure.

FIG. 10 is an enlargement view of a light cover of an LED lighting device in accordance with a third embodiment of the disclosure.

FIG. 11 is a sectional view of the LED lighting device in accordance with the third embodiment of the disclosure.

FIG. 12 is a sectional view of an LED lighting device in accordance with still a fourth embodiment of the disclosure.

FIG. 13 is an exploded view of an LED lighting device in accordance with a fifth embodiment of the disclosure.

FIG. 14 is a first sectional view of the LED lighting device in accordance with the fifth embodiment of the disclosure.

FIG. 15 is a second sectional view of the LED lighting device in accordance with the fifth embodiment of the disclosure.

FIG. 16 is a sectional view of a first protective layer of an LED lighting device in accordance with a sixth embodiment of the disclosure.

FIG. 17 is a sectional view of a flexible board of an LED lighting device in accordance with a seventh embodiment of the disclosure.

FIG. 18 is a sectional view of a reinforcing structure of an LED lighting device in accordance with an eighth embodiment of the disclosure.

FIG. 19 is a first schematic view of a flexible board of an LED lighting device in accordance with a ninth embodiment of the disclosure.

FIG. 20 is a second schematic view of the flexible board of the LED lighting device in accordance with the ninth embodiment of the disclosure.

FIG. 21A is a third schematic view of the flexible board of the LED lighting device in accordance with the ninth embodiment of the disclosure.

FIG. 21B is a fourth schematic view of the flexible board of the LED lighting device in accordance with the ninth embodiment of the disclosure.

FIG. 22 is a first schematic view of a structure of a high-compatibility direct-current light source board in accordance with a tenth embodiment of the disclosure.

FIG. 23 is a second schematic view of the structure of the high-compatibility direct-current light source board in accordance with the tenth embodiment of the disclosure.

FIG. 24 is a third schematic view of the structure of the high-compatibility direct-current light source board in accordance with the tenth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

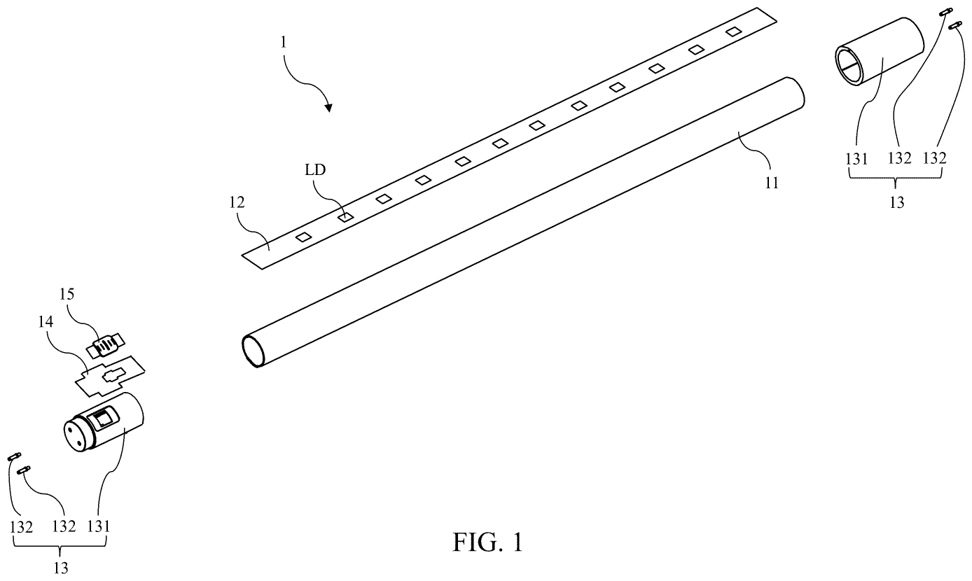

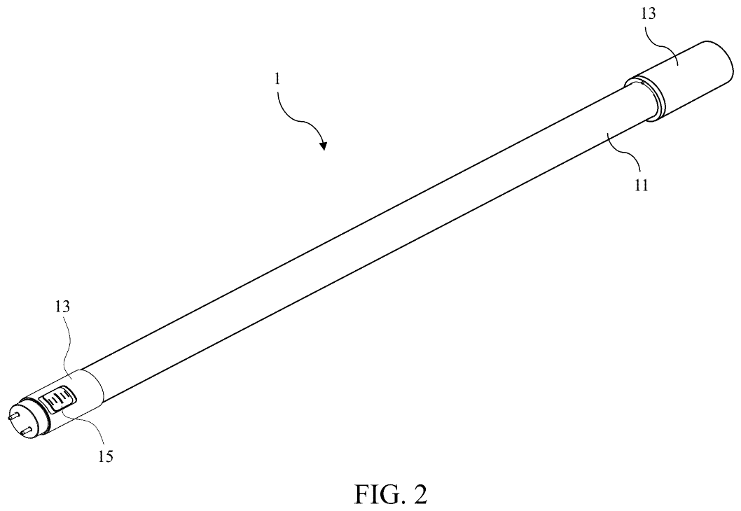

Please refer to FIG. 1 and FIG. 2. FIG. 1 is an exploded view of a light-emitting diode (LED) lighting device in accordance with a first embodiment of the disclosure. FIG. 2 is a perspective view of the LED lighting device in accordance with the first embodiment of the disclosure. As shown in FIG. 1 and FIG. 2, the LED lighting device 1 includes a light cover 11, a circuit board 12, two end caps 13, a power supplier 14, a color temperature switch 15 and a plurality of light sources LD. In this embodiment, the LED lighting device 1 is an LED light tube. In another embodiment, the LED lighting device 1 may be an LED panel light, LED ceiling light or other currently available lighting devices.

The circuit board 12 is disposed in the light cover 11. In this embodiment, the circuit board 12 is a flexible printed circuit board (FPCB). In another embodiment, the circuit board 12 is a printed circuit board. In this embodiment, the light cover 11 may be tubular. In another embodiment, the light cover 11 may be a flat circular box, a flat rectangular box, etc. In one embodiment, the light cover 11 may be made of a transparent material or a translucent material, such as plastics, glass, etc.

The two end caps 13 are disposed at the two ends of the light cover 12 and the power supplier 14 is disposed in one of the end caps 13 and electrically connected to the circuit board 12. Each of the end caps 13 includes a casing 131 and two metal pins 132 (e.g., copper, iron, aluminum, etc.). The metal pins 132 are disposed on the casing 131 and electrically connected to the power supplier 14 and the circuit board 12. In one embodiment, the power supplier 14 is an LED power supplier, which may include converters, rectifiers, filters and other necessary electronic components; the details of the power supplier 14 are known by those skilled in the art, so will not be described herein.

The light sources LD are disposed on the circuit board 12 and electrically connected to the circuit board 12. In this embodiment, the light sources LD are LEDs. In another embodiment, the light sources LD may be an LED light strip.

The color temperature switch 15 is disposed on one of the end caps 13 and connected to the power supplier 14. The user can operate the color temperature switch 15 to adjust the color temperature of the light sources LD. In another embodiment, the color temperature switch 15 may be replaced by a dimming switch, or the LED lighting device 1 may have both of the color temperature switch 15 and the dimming switch.

The embodiment just exemplifies the disclosure and is not intended to limit the scope of the disclosure; any equivalent modification and variation according to the spirit of the disclosure is to be also included within the scope of the following claims and their equivalents.

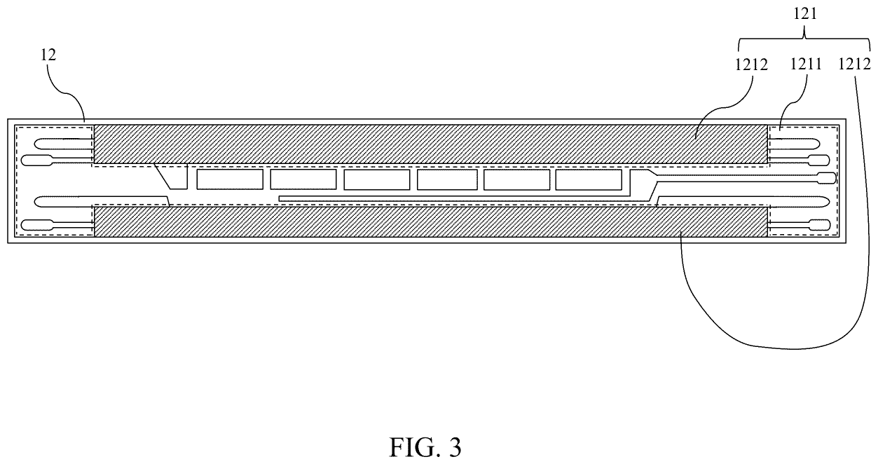

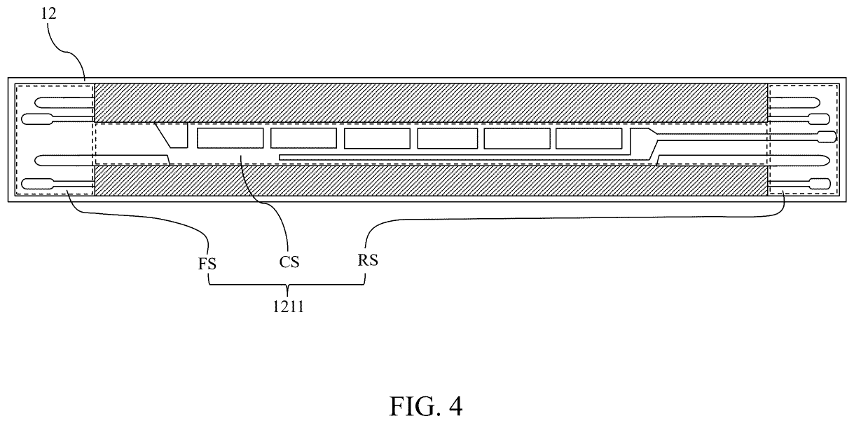

Please refer to FIG. 3 and FIG. 4. FIG. 3 is a first schematic view of a circuit board of the LED lighting device in accordance with the first embodiment of the disclosure. FIG. 4 is a second schematic view of the circuit board of the LED lighting device in accordance with the first embodiment of the disclosure. As shown in FIG. 3, the circuit board 12 has a protective layer 121. The protective layer 121 includes an opening 1211 and two coated layers 1212. The coated layers 1212 may be ink layers capable of providing the insulating function and protecting the circuit board 12. The material of the coated layers 1212 is known by those skilled in the art, so will not be described herein.

As shown in FIG. 4, the opening 1211 includes a front section FS, a rear section RS and a connecting section CS. In this embodiment, the shape of the connecting section CS is a straight line. The front section FS is connected to the rear section RS via the connecting section CS, such that the opening 1211 can be H-shaped. The coated layers 1212 are disposed on the two sides of the connecting section CS respectively.

The embodiment just exemplifies the disclosure and is not intended to limit the scope of the disclosure; any equivalent modification and variation according to the spirit of the disclosure is to be also included within the scope of the following claims and their equivalents.

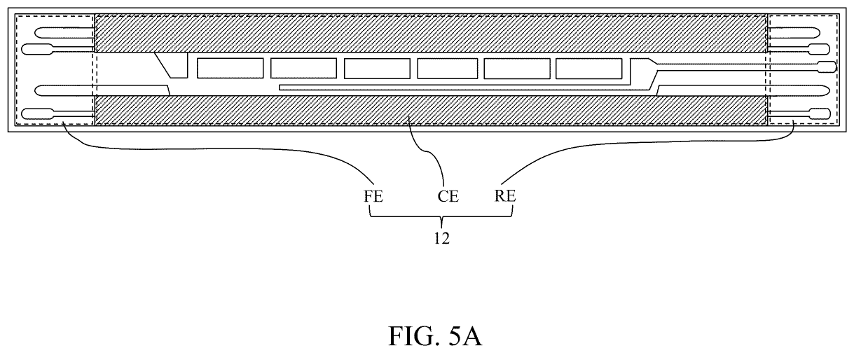

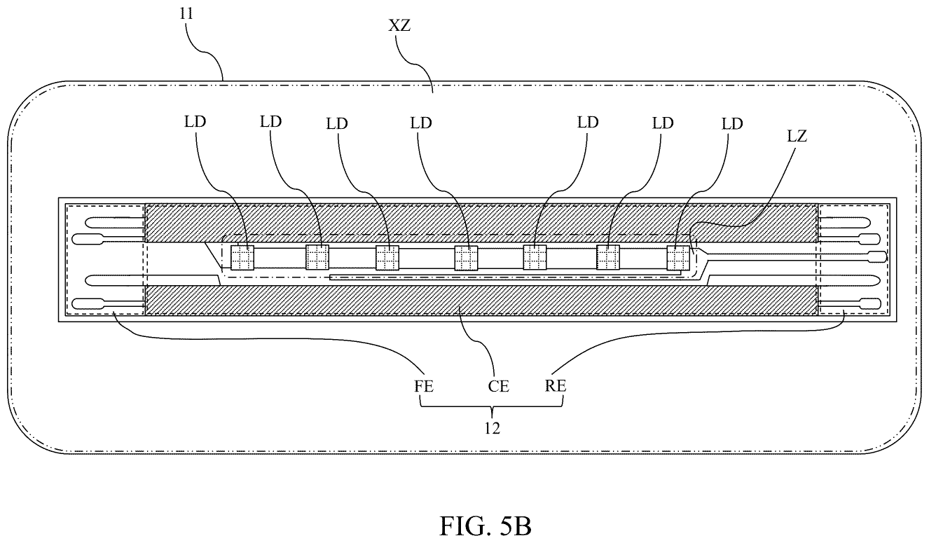

Please refer to FIG. 5A, which is a third schematic view of the circuit board of the LED lighting device in accordance with the first embodiment of the disclosure. As shown in FIG. 5A, the circuit board 12 has a front soldering section FE, a rear soldering section RE and a circuit section CE. The front soldering section FE is electrically connected to the rear soldering section RE via the circuit section CE. The light sources LD are disposed on the circuit section CE and electrically connected to the circuit section CE. Any one of the coated layers 1212 of the protective layer 121 is separated from the front soldering section FE by a predetermined distance (in one embodiment, the predetermined distance may be greater than 4 m). Similarly, any one of the coated layers 1212 of the protective layer 121 is separated from the rear soldering section RE by the predetermined distance. The aforementioned predetermined distance can avoid that the halogen elements of the protective layer 121 move to the front soldering section FE and the rear soldering section RE of the circuit board 12.

The front soldering section FE has several connecting points, which may include a positive electrode, a negative electrode, a grounding point, etc. The rear soldering section RE also has the same structure. The circuit section CE has a plurality of traces. The light sources LD are disposed on the circuit board 12 and within the connecting section CE so as to electrically connect to the trances, such that the light sources LD can be electrically connected to the front soldering section FE and the rear soldering section RE via these traces.

As previously stated, the protective layer 121 of the circuit board 12 of the lighting device 1 have only one opening 1211. Therefore, the coating process of the protective layer 121 can be significantly simplified, such that the manufacturing cost of the LED lighting device 1 can be greatly reduced.

Besides, the above structural design can avoid that the halogen elements of the protective layer 121 move to the front soldering section FE and the rear soldering section RE of the circuit board 12. As a result, the front soldering section FE and the rear soldering section RE of the circuit board 12 will not be oxidized, which can make sure that the front soldering section FE and the rear soldering section RE of the circuit board 12 can achieve great conductivity and soldering effect during the manufacturing process.

In addition, the circuit board 12 of the LED lighting device 1 may further include a multi-function layer (not shown in the drawings). The multi-function layer can cover the opening 1211 of the protective layer 121 and the light sources LD disposed on the circuit board 12. The multi-function layer may be a transparent ink layer and can provide one or more of antioxidant function, insulating function, light reflecting function, moisture-proof function, etc. The material of the multi-function layer is known by those skilled in the art, so will not be described herein. Therefore, the LED lighting device 1 can have high reliability with a view to improving the overall quality thereof.

The embodiment just exemplifies the disclosure and is not intended to limit the scope of the disclosure; any equivalent modification and variation according to the spirit of the disclosure is to be also included within the scope of the following claims and their equivalents.

Please refer to FIG. 5B, which is a fourth schematic view of the circuit board of the LED lighting device in accordance with the first embodiment of the disclosure. As shown in FIG. 5B, the circuit board 12 disposed in the light cover 11. The light sources LD are disposed within the connecting section CE, so a light-emitting zone LZ is formed (the light-emitting zone LZ is shown in FIG. 5B by one-point chain line; the light-emitting zone LZ stands for the zone which can emit light).

The light-emitting zone LZ can emit light, and the light can spread over the inner space of the light cover 11 to make the inner space of the light cover 11 form an optical zone XZ (the optical zone XZ is shown in FIG. 5B by two-point chain line; the optical zone XZ stands for the zone inside the light cover 11 filled with light). The optical section XZ simultaneously covers the light-emitting section LZ, the front soldering section FE and the rear soldering section RE.

Via the above optical structure design, the optical zone XZ of the light cover 11 can be further extended to cover the front soldering section FE and the rear soldering section RE of the circuit board 12 (the power supplier 14 is still outside the optical zone XZ), which can further expand the optical zone XZ of the light cover 11. Thus, the overall light-emitting area of the LED lighting device 1 can be significantly increased, so the light efficiency of the LED lighting device 1 can be enhanced.

The embodiment just exemplifies the disclosure and is not intended to limit the scope of the disclosure; any equivalent modification and variation according to the spirit of the disclosure is to be also included within the scope of the following claims and their equivalents.

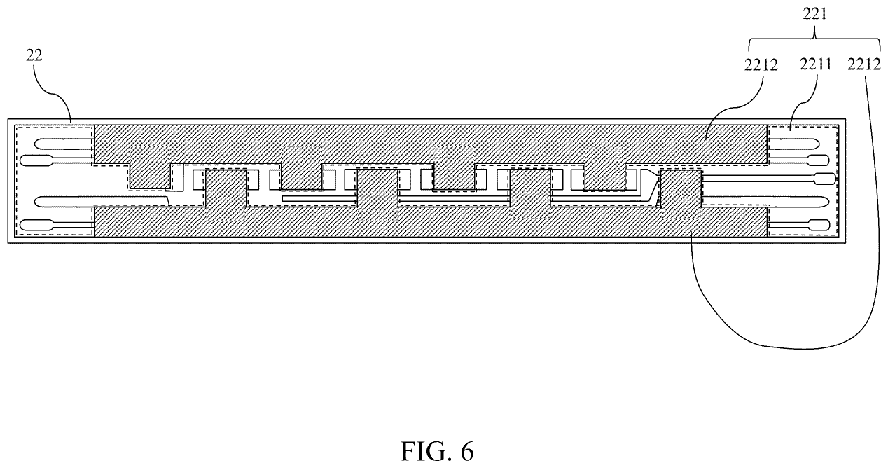

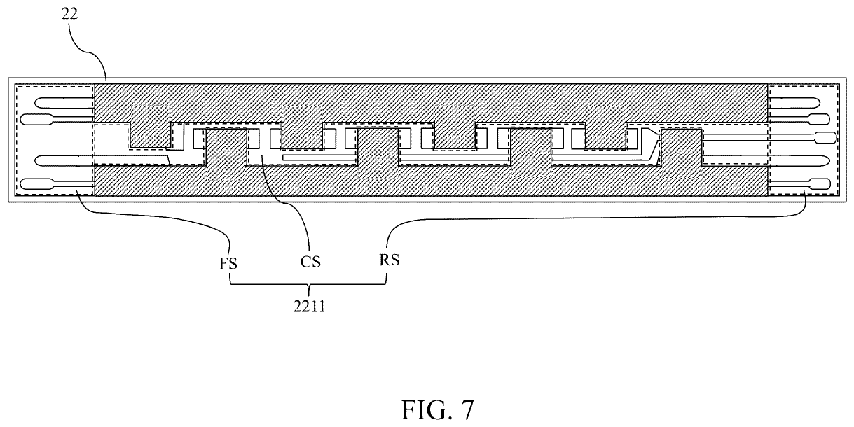

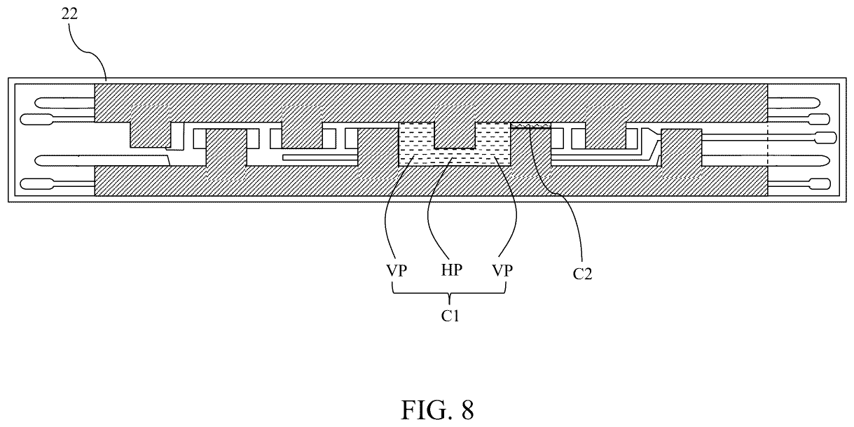

Please refer to FIG. 6, FIG. 7 and FIG. 8. FIG. 6 is a first schematic view of a circuit board of the LED lighting device in accordance with a second embodiment of the disclosure. FIG. 7 is a second schematic view of the circuit board of the LED lighting device in accordance with the second embodiment of the disclosure. FIG. 8 is a third schematic view of the circuit board of the LED lighting device in accordance with another embodiment of the disclosure. As shown in FIG. 6, the circuit board 22 has a protective layer 221. The protective layer 221 includes an opening 2211 and two coated layers 2212. Similarly, the coated layers 2212 may be ink layers capable of providing the insulating function and protecting the circuit board 22.

As shown in FIG. 7, the opening 2211 includes a front section FS, a rear section RS and a connecting section CS. The front section FS is connected to the rear section RS via the connecting section CS. The coated layers 2212 are disposed on the two sides of the connecting section CS respectively.

As shown in FIG. 8, the difference between this embodiment and the previous embodiment is that the connecting section CS of the opening 2211 includes a plurality of bending portions C1 and a plurality of connecting portions C2 connected to each other and arranged in an alternating order. Any one of the bending portions C1 is connected to the bending portion C1 adjacent thereto via one of the connecting portions C2.

In this embodiment, each of the bending portions C1 includes two vertical portions VP and a horizontal portion HP connected to each other and perpendicular to each other, such that the shape of the bending portion C1 is U-shaped. In another embodiment, the shape of the bending portion C1 may be inverted U-shaped. In still another embodiment, each of the bending portions C1 may have only one vertical portions VP and one horizontal portion HP connected to each other and perpendicular to each other. The structure of the bending portion C1 can be changed according to actual requirements.

Besides, the width of the horizontal portion HP is greater than the width of the connecting portion C2. In another embodiment, the width of the horizontal portion HP may be equal to or less than the width of the connecting portion C2. Therefore, in this embodiment, the shape of the connecting section CS is a rectangular wave. In another embodiment, the shape of the connecting section CS may be a sinusoidal wave. Of course, the shape of the connecting section CS can be changed according to actual requirements.

The embodiment just exemplifies the disclosure and is not intended to limit the scope of the disclosure; any equivalent modification and variation according to the spirit of the disclosure is to be also included within the scope of the following claims and their equivalents.

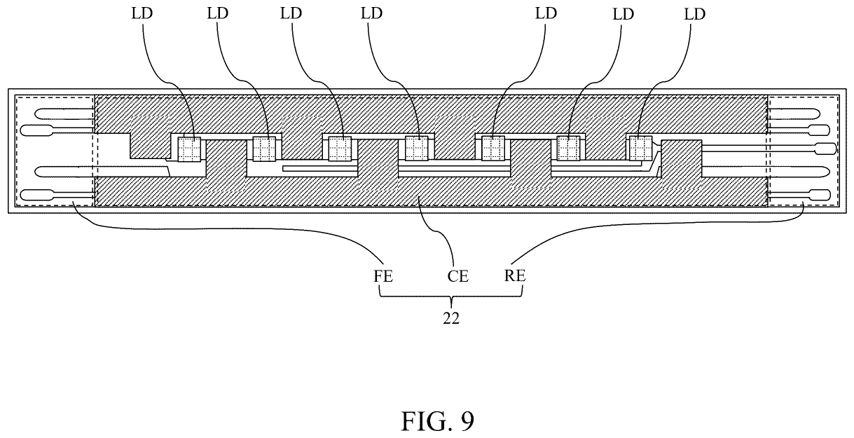

Please refer to FIG. 9, which is a fourth schematic view of the circuit board of the LED lighting device in accordance with the second embodiment of the disclosure. As shown in FIG. 9, the circuit board 22 has a front soldering section FE, a rear soldering section RE and a circuit section CE. The front soldering section FE is electrically connected to the rear soldering section RE via the circuit section CE. The light sources LD are disposed on the circuit section CE (and within the connecting section CE) and electrically connected to the circuit section CE. Any one of the coated layers 2212 of the protective layer 221 is separated from the front soldering section FE by a predetermined distance (as set forth above, the predetermined distance may be greater than 4 m). Similarly, any one of the coated layers 2212 of the protective layer 221 is separated from the rear soldering section RE by the predetermined distance. The structure of the circuit board 22 is the same with that of the circuit board 22 of the previous embodiment, so will not be described herein again.

As previously stated, the protective layer 221 of the circuit board 22 have only one opening 2211. Therefore, the coating process of the protective layer 221 can be significantly simplified, such that the manufacturing cost of the LED lighting device can be greatly reduced.

Moreover, since the shape of the opening 2211 of the protective layer 221 is a rectangular wave (serrated), each of the coated layers 2212 has several protrusions, so the area of the protective layer 221 can increase. Accordingly, the protective layer 221 can cover more of the area of the surface of the circuit board 22 so as to more effectively protect the circuit board 22.

Similarly, the above structural design can avoid that the halogen elements of the protective layer 221 move to the front soldering section FE and the rear soldering section RE of the circuit board 22. As a result, the front soldering section FE and the rear soldering section RE of the circuit board 22 will not be oxidized, which can make sure that the front soldering section FE and the rear soldering section RE of the circuit board 22 can achieve great conductivity and soldering effect during the manufacturing process. The circuit board 22 may also include a multi-function layer (not shown in the drawings).

The embodiment just exemplifies the disclosure and is not intended to limit the scope of the disclosure; any equivalent modification and variation according to the spirit of the disclosure is to be also included within the scope of the following claims and their equivalents.

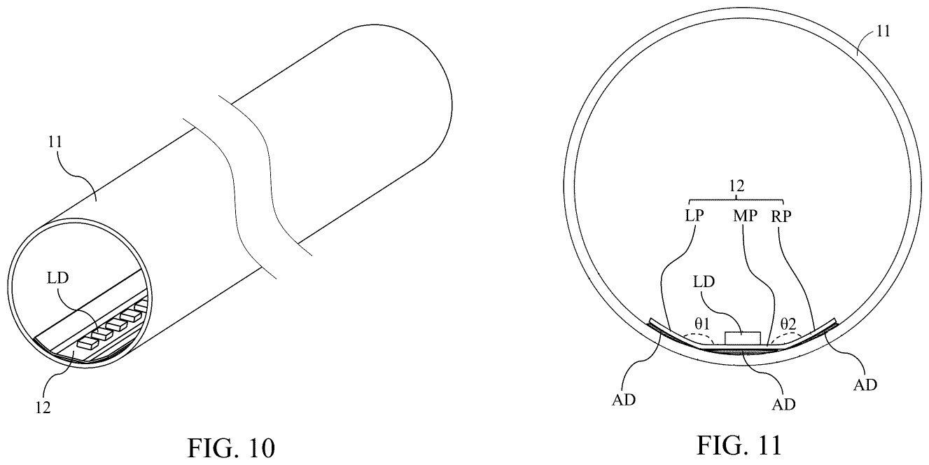

Please refer to FIG. 10 and FIG. 11. FIG. 10 is an enlargement view of a light cover of an LED lighting device in accordance with a third embodiment of the disclosure. FIG. 11 is a sectional view of the LED lighting device in accordance with the third embodiment of the disclosure. As shown in FIG. 10 and FIG. 11, the difference between this embodiment and the previous embodiments is that the circuit board 12 of this embodiment is bent. The circuit board 12 may be a flexible printed circuit board (FPCB).

The circuit board 12 includes a left-wing portion LP, a right-wing portion RP, and a flat portion MP. The left-wing portion LP, right-wing portion RP, and flat portion MP are flat (planar in shape). The left-wing portion LP and the right-wing portion RP respectively extend from both sides of the flat portion MP, such that the flat portion MP is located between the left-wing portion LP and right-wing portion RP. The left-wing portion LP and the right-wing portion RP are not parallel to the flat portion MP. Thus, the circuit board 12 may be bent. In another embodiment, the left-wing portion LP and the right-wing portion RP may also be bent.

An included angle θ1 is formed between the left-wing portion LP and the flat portion MP, and the included angle θ1 is greater than 90°. An included angle θ2 is formed between the right-wing portion RP and the flat portion MP, and the included angle θ2 is also greater than 90°. For example, the included angles θ1 and θ2 may be 150°. In other examples, the included angles θ1 and θ2 may be 160°, or even 165°. The included angles θ1 and θ2 may vary according to actual requirements, so that the circuit board 12 can conform as closely as possible to the inner surface of the light cover 11. The circuit board 12 may be adhered to the inner surface of the light cover 11 via an adhesive material AD. During the process of adhering the circuit board 12 to the inner surface of the light cover 11 with the adhesive material AD, the adhesive material AD is flattened and forms a uniform protective layer. In one embodiment, the adhesive material AD may be silicone adhesive, epoxy resin, thermally conductive silicone, or other currently available adhesive compounds.

If the circuit board 12 is planar, it would experience significant stress when fixed to the inner surface of the light cover 11, possibly leading to damage due to stress. In contrast, in this embodiment, since the circuit board 12 is bent, the stress exerted on the circuit board 12 can be greatly reduced. In addition, the protective layer formed by the adhesive material AD can further disperse stress, thereby further reducing the stress applied to the circuit board 12. As such, the service life of the LED lighting device 1 can be significantly extended, meeting actual requirements.

The embodiment just exemplifies the disclosure and is not intended to limit the scope of the disclosure; any equivalent modification and variation according to the spirit of the disclosure is to be also included within the scope of the following claims and their equivalents.

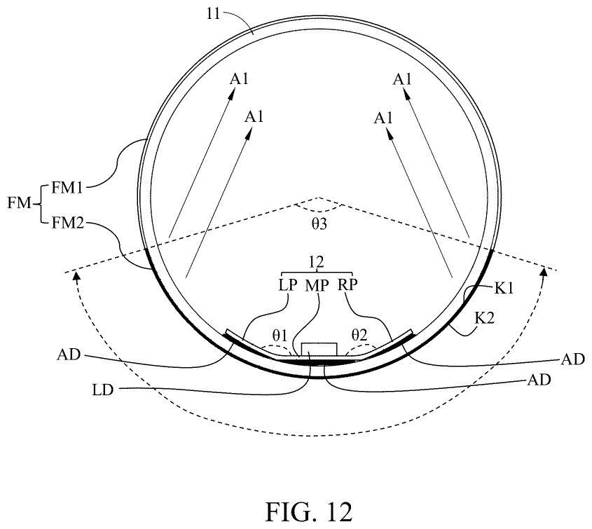

Please refer to FIG. 12, which is a sectional view of an LED lighting device in accordance with a fourth embodiment of the disclosure. As shown in FIG. 12, the difference between this embodiment and the previous embodiments is that the surface of the light cover 11 is enclosed by an optical film FM. The optical film FM includes a transparent portion FM1 and a non-transparent portion FM2. In one embodiment, the optical film FM may be made from polymer materials of at least two different colors, such as PET, OPP, or other similar materials.

The distance between the non-transparent portion FM2 and the circuit board 12 is less than the distance between the transparent portion FM1 and the circuit board 12. As can be seen in the figure, the non-transparent portion FM2 is located closer to the circuit board 12; therefore, the transparent portion FM1 faces the light sources LD. The area of the non-transparent portion FM2 is greater than or at least equal to the area of the circuit board 12, allowing the non-transparent portion FM2 to conceal(cover) the adhesive material AD. The central angle θ3 corresponding to the arc formed by the cross-section of the optical film FM may range from 30° to 180°. For example, the central angle may be 35°, 60°, 100°, 130°, or 170°. The central angle may vary depending on actual requirements to meet different application needs.

In addition, the inner surface of the non-transparent portion FM2 serves as a reflective surface K1, while the outer surface of the non-transparent portion FM2 functions as a light-shielding surface K2. The light-blocking surface K2 can effectively block light. Most of the light emitted by the light source LD passes directly through the transparent portion FM1, while a portion of the light is reflected by the reflective surface K1 and also passes through the transparent portion FM1. In this way, the light efficacy of the LED lighting device 1 can be further improved, thereby enhancing the overall performance of the LED lighting device 1.

With the dual-color optical film design described above, traces of the adhesive material AD can be shielded by the non-transparent portion FM2 of the optical film FM, thereby improving the appearance of the LED lighting device 1 and effectively enhancing the user experience. In addition, light emitted from the light sources LD can still pass through the transparent portion FM1 of the optical film FM to provide lighting function.

On the other hand, the outer surface of the optical film FM can also include various patterns or text, which can further enhance the appearance of the LED lighting device 1 and increase the perceived quality thereof, thereby meeting the preferences of different users.

Further, since the optical film FM includes the transparent portion FM1 and non-transparent portion FM2, the user can easily identify the non-transparent portion FM2 during installation of the LED lighting device 1, allowing the user to quickly locate the transparent portion FM1 (which serves as the light-emitting surface). Therefore, with the dual-color optical film design, the user can install the LED lighting device 1 more conveniently.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the disclosure, the LED lighting device includes a power supplier, a light cover and a circuit board. The circuit board is disposed in the light cover and adhered to the inner surface of the light cover via an adhesive material. The circuit board has a protective layer disposed thereon and a plurality of light sources. The circuit board has a front soldering section, a rear soldering section and a circuit section. The front soldering section is electrically connected to the rear soldering section via the circuit section, and the front soldering section and the rear soldering section are electrically connected to the power supplier. The light sources are disposed on the circuit section and electrically connected to the circuit section. The circuit board includes a left-wing portion, a right-wing portion, and a flat portion disposed therebetween. The left-wing portion and the right-wing portion respectively extend from the two sides of the flat portion, and are not parallel to the flat portion, such that the circuit board is bent. The protective layer includes an opening and two coated layers. The opening includes a front section, a rear section and a connecting section. The front section is connected to the rear section via the connecting section, and the coated layers are disposed on the two sides of the connecting section respectively. The light sources are within the connecting section to serve as a light-emitting zone. The light-emitting zone makes the inner space of the light cover form an optical zone, such that the optical zone simultaneously covers the light-emitting zone, the front soldering section and the rear soldering section. Via the above-mentioned circuit board structural design, the stress applied to the circuit board adhered to the inner surface of the light cover can be significantly reduced, thereby preventing damage to the circuit board caused by stress. As a result, the service life of the LED lighting device can be greatly extended to meet actual requirements.

Also, according to one embodiment of the disclosure, the surface of the light cover is enclosed by an optical film, and the optical film includes a transparent portion and a non-transparent portion. The non-transparent portion is adjacent to the circuit board, such that the adhesive material is covered by the non-transparent portion. With the dual-color optical film design described above, traces of the adhesive material can be shielded by the non-transparent portion of the optical film, thereby improving the appearance of the LED lighting device and effectively enhancing the user experience. In addition, light emitted from the light sources can still pass through the transparent portion of the optical film to provide lighting function.

Further, according to one embodiment of the disclosure, the non-transparent portion has a reflective surface contacting the light cover and a light-shielding surface not contacting the light cover. Via the reflective surface of the optical film, a portion of the light emitted from the light sources can be reflected by the reflective surface and passes through the transparent portion of the optical film. In this way, the light efficacy of the LED lighting device can be further improved, thereby enhancing the overall performance of the LED lighting device. Thus, the practicality of the LED lighting device can be improved to meet various application requirements.

Moreover, according to one embodiment of the disclosure, since the optical film includes the transparent portion and non-transparent portion, the user can easily identify the non-transparent portion during installation of the LED lighting device, allowing the user to quickly locate the transparent portion (which serves as the light-emitting surface). Therefore, with the dual-color optical film design, the user can install the LED lighting device more conveniently.

Moreover, according to one embodiment of the disclosure, the outer surface of the optical film can also include various patterns or text, which can further enhance the appearance of the LED lighting device and increase the perceived quality thereof, thereby meeting the preferences of different users.

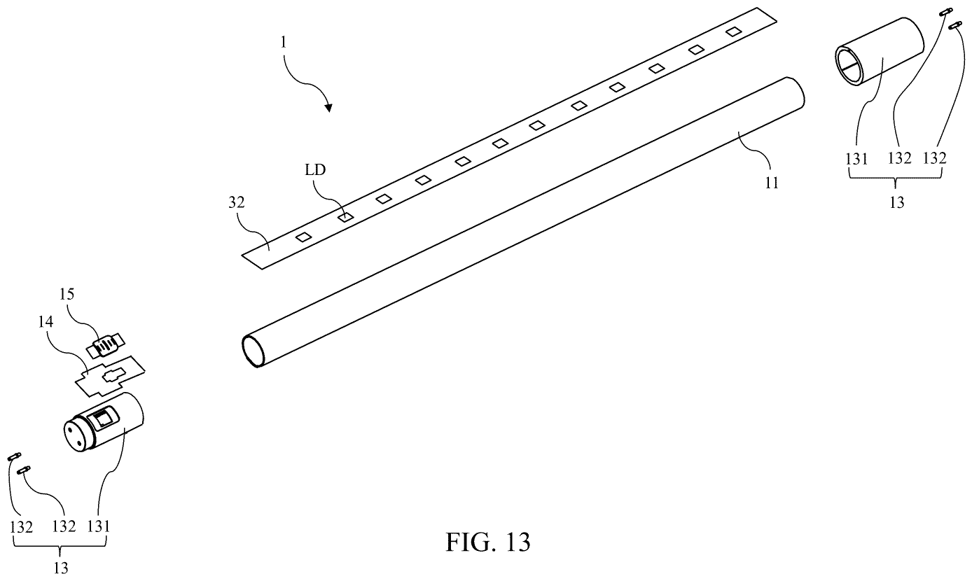

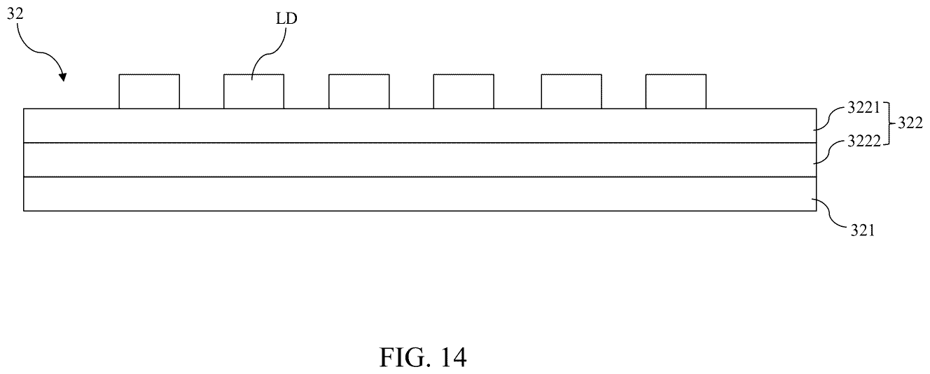

Please refer to FIG. 13 and FIG. 14. FIG. 13 is an exploded view of an LED lighting device in accordance with a fifth embodiment of the disclosure. FIG. 14 is a first sectional view of the LED lighting device in accordance with the fifth embodiment of the disclosure. As shown in FIG. 13 and FIG. 14, the light-emitting diode lighting device 1 includes a light cover 11, a flexible board 32, two end caps 13, a power supplier 14, a color temperature switch 15 (optional), and a plurality of light sources LD. The perspective view of the light-emitting diode lighting device 1 is shown in FIG. 2. In the present embodiment, the light-emitting diode lighting device 1 is an LED light tube. In another embodiment, the light-emitting diode lighting device 1 may also be an LED panel light, an LED ceiling light, or other existing lighting devices.

The above-mentioned components are the same as those of the first embodiment and therefore are not described herein again. The difference from the first embodiment lies in that the circuit board 12 is replaced with a flexible board 32.

The flexible board 32 is electrically connected to the power supplier 14 and includes a substrate 321 and a laminated structure 322. The laminated structure 322 is disposed on the first surface (upper surface) of the substrate 321. The substrate 321 may be made of polyimide (PI) or other similar plastic materials.

The laminated structure 322 includes a transparent ink layer 3221 and a first protective layer 3222. The transparent ink layer 3221 is disposed on the first protective layer 3222. In the present embodiment, the first protective layer 3222 may be an ink layer.

The light sources LD are disposed on the laminated structure 322 and are electrically connected to the flexible board 32. The substrate 321 may include a plurality of pads (not shown). Each of the pads may pass through the laminated structure 322 and be soldered to a corresponding light source LD. Accordingly, the light sources LD are electrically connected to the flexible board 32.

From the foregoing, it can be understood that the flexible board 32 of the light-emitting diode lighting device 1 has a multifunctional laminated structure 322. The transparent ink layer 3221 of the laminated structure 322 can effectively enhance the arc resistance of the flexible board 32 and further improve the appearance of the flexible board 32. In addition, the first protective layer 3222 of the laminated structure 322 can effectively increase reflectivity and further enhance insulation performance and solder resist performance. Accordingly, by virtue of the laminated structure 322 described above, the performance of the flexible board 32 can be significantly improved so as to meet actual requirements.

The embodiment just exemplifies the disclosure and is not intended to limit the scope of the disclosure; any equivalent modification and variation according to the spirit of the disclosure is to be also included within the scope of the following claims and their equivalents.

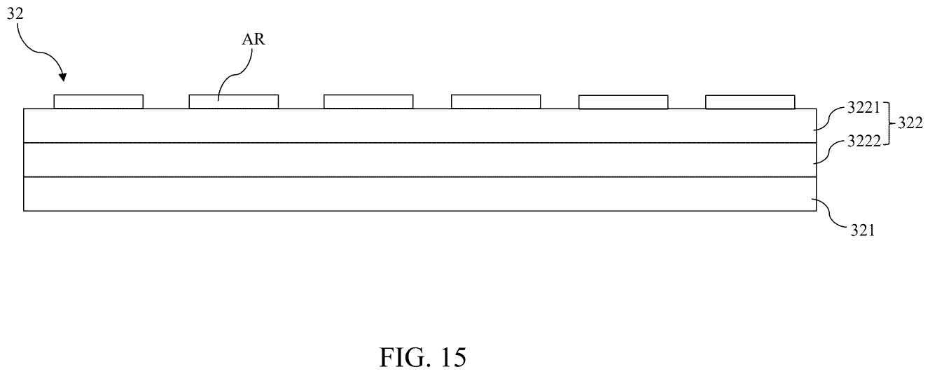

Please refer to FIG. 15, which is a second sectional view of the LED lighting device in accordance with the fifth embodiment of the disclosure. As shown in FIG. 15, before the light sources 16 are disposed on the laminated structure 322, the flexible board 32 may further include an anti-oxidation layer (OSP) AR covering the pads to prevent oxidation of the pads. The anti-oxidation layer (OSP) AR disappears after completion of the soldering process.

The embodiment just exemplifies the disclosure and is not intended to limit the scope of the disclosure; any equivalent modification and variation according to the spirit of the disclosure is to be also included within the scope of the following claims and their equivalents.

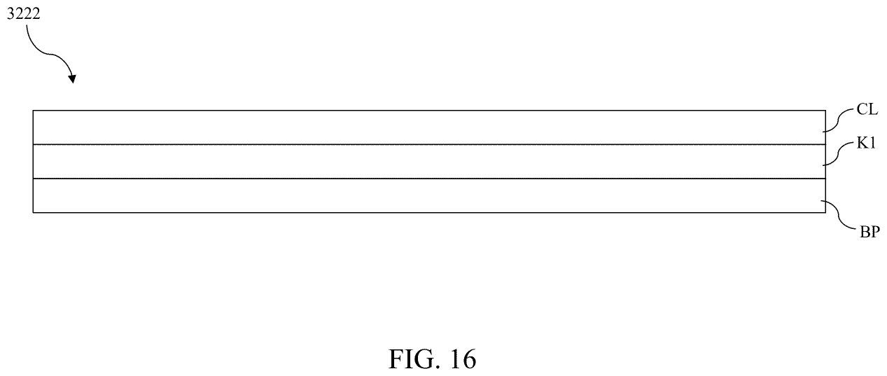

Please refer to FIG. 16, which is a sectional view of a first protective layer of an LED lighting device in accordance with a sixth embodiment of the disclosure. As shown in FIG. 16, the difference between this embodiment and the fifth embodiment is that the first protective layer 3222 is a cover film. The cover film includes a bottom plate BP, a first adhesive layer K1, and an ink layer CL. The first adhesive layer K1 is disposed on the bottom plate BP, and the ink layer CL is disposed on the first adhesive layer K1. The bottom plate BP may be made of polyimide (PI) or other similar plastic materials. The first adhesive layer K1 may be glue or various adhesive materials.

The cover film can effectively enhance the structural strength of the flexible board 32 so that it is less likely to break. In addition, the cover film can further improve the reflectivity, insulation performance, and solder resist performance of the flexible board 32.

The embodiment just exemplifies the disclosure and is not intended to limit the scope of the disclosure; any equivalent modification and variation according to the spirit of the disclosure is to be also included within the scope of the following claims and their equivalents.

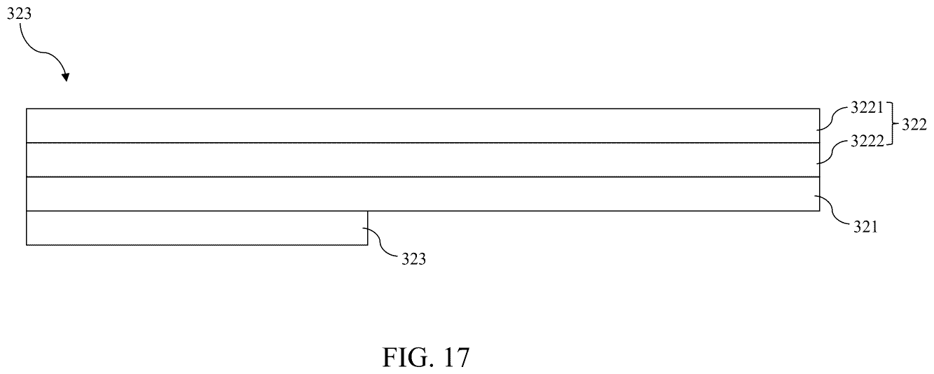

Please refer to FIG. 17, which is a sectional view of a flexible board of an LED lighting device in accordance with a seventh embodiment of the disclosure. As shown FIG. 17, the difference between this embodiment and the sixth embodiment is that the flexible board 32 further includes a reinforcing structure 323. The reinforcing structure 323 is disposed on the second surface of the substrate 321 and partially covers the second surface of the substrate 321. In another embodiment, the reinforcing structure 323 may entirely cover the second surface of the substrate 321. In this embodiment, the reinforcing structure 323 is a backing adhesive (double-sided adhesive tape).

The reinforcing structure 323 can effectively enhance the structural strength of the flexible board 32 so as to prevent breakage of the flexible board 32. Accordingly, the reinforcing structure 323 may be disposed at the portions of the flexible board 32 that require bending, so as to enhance the structural strength of such portions.

The embodiment just exemplifies the disclosure and is not intended to limit the scope of the disclosure; any equivalent modification and variation according to the spirit of the disclosure is to be also included within the scope of the following claims and their equivalents.

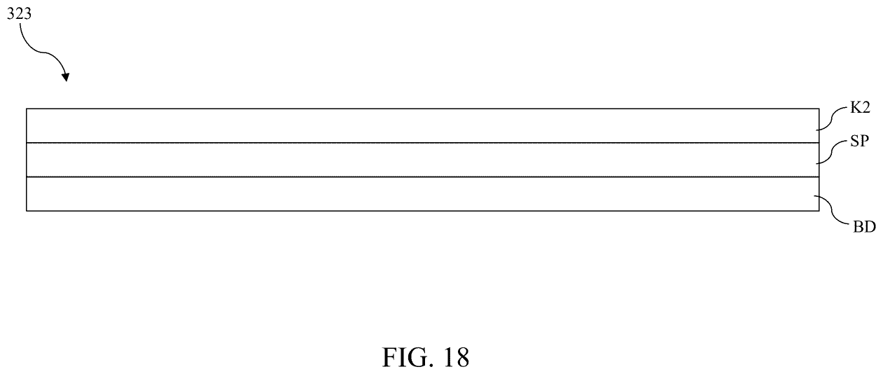

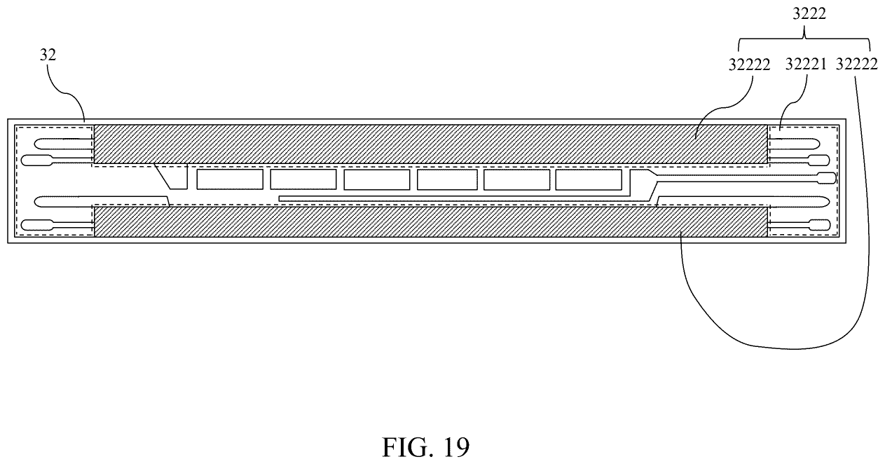

Please refer to FIG. 18, which is a sectional view of a reinforcing structure of an LED lighting device in accordance with an eighth embodiment of the disclosure. As shown in FIG. 18, the difference between this embodiment and the seventh embodiment is that the reinforcing structure 323 includes a backing adhesive BD, a second protective layer SP, and a second adhesive layer K2. The backing adhesive (double-sided adhesive tape) BD is disposed on the second protective layer SP. The second protective layer SP is disposed on the second adhesive layer K2. The second adhesive layer K2 is disposed on the second surface of the substrate 321. The second adhesive layer K2 may be glue or various adhesive materials. The second protective layer SP may be an ink layer. In another embodiment, the second protective layer SP may also be a cover film (as shown in FIG. 19).

The reinforcing structure 323 can also effectively enhance the structural strength of the flexible board 32 so as to prevent breakage of the flexible board 32. Meanwhile, the reinforcing structure 323 can further improve the insulation performance of the flexible board 32.

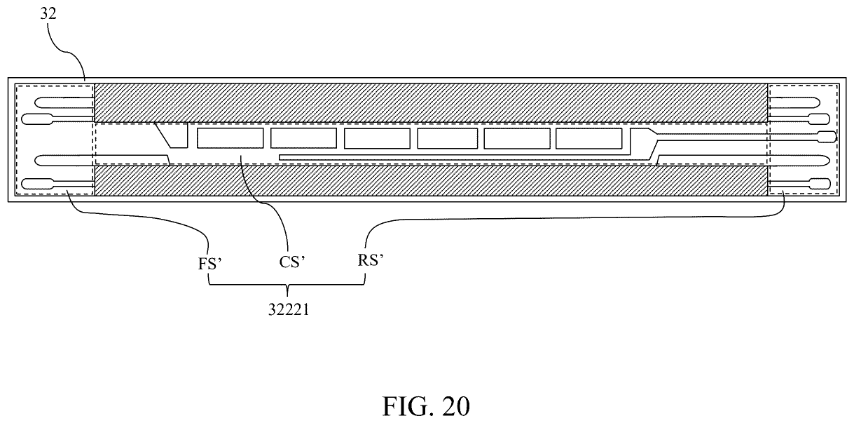

Please refer to FIG. 19 and FIG. 20. FIG. 19 is a first schematic view of a flexible board of an LED lighting device in accordance with a ninth embodiment of the disclosure. FIG. 20 is a second schematic view of the flexible board of the LED lighting device in accordance with the ninth embodiment of the disclosure. As shown in FIG. 19, the flexible board 32 has a laminated structure 322. The first protective layer 3222 of the laminated structure 322 includes an opening 32221 and two sub protective layers 32222.

As shown in FIG. 20, the opening 32221 includes a front section FS′, a rear section RS′, and a connecting section CS′. In this embodiment, the connecting section CS′ is a straight line. The front section FS′ is connected to the rear section RS′ through the connecting section CS′, such that the opening 32221 can be H-shaped. The two sub protective layers 32222 are respectively disposed on the two sides of the connecting section CS′. The projection of any one of the light sources LD on the first protective layer 3222 is located within the connecting section CS′.

In another embodiment, the connecting section CS′ includes a plurality of bending portions and a plurality of connecting portions that are connected to each other. The bending portions and the connecting portions are arranged in an alternating order. Each of the bending portions includes at least one vertical portion and one horizontal portion that are connected to each other and perpendicular to each other. The width of the horizontal portion is greater than the width of the connecting portion. In this embodiment, each of the bending portions may be U-shaped In another embodiment, each of the bending portions may be inverted U-shaped. The specific structure of the bending portions may be adjusted according to actual requirements. The above structure is similar to that shown in FIG. 8 and therefore is not described herein again.

The embodiment just exemplifies the disclosure and is not intended to limit the scope of the disclosure; any equivalent modification and variation according to the spirit of the disclosure is to be also included within the scope of the following claims and their equivalents.

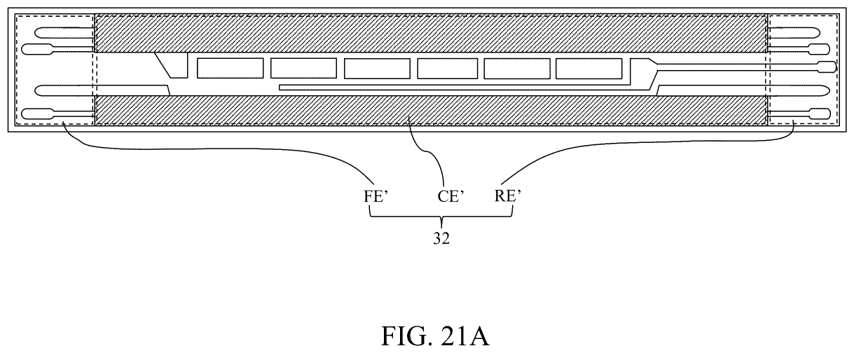

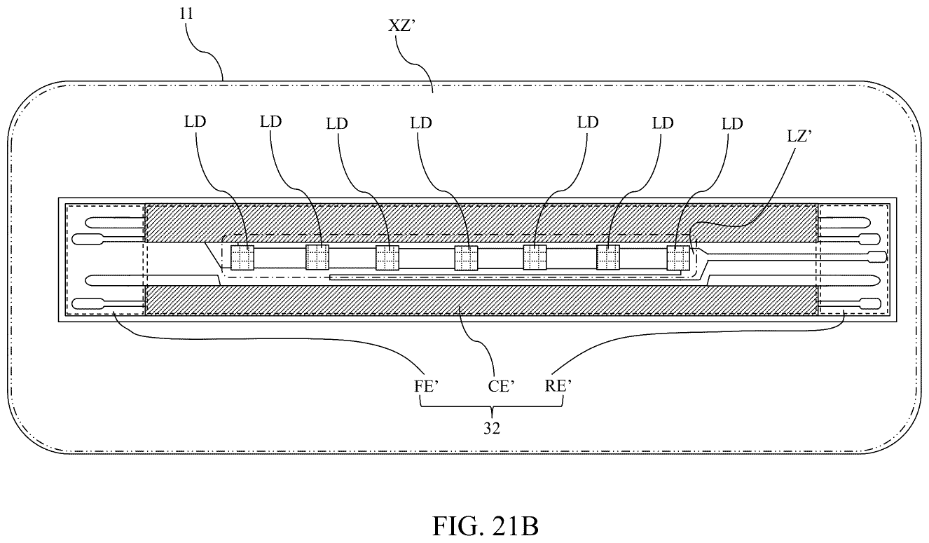

Please refer to FIG. 21A, which is a third schematic view of the flexible board of the LED lighting device in accordance with the ninth embodiment of the disclosure. As shown in FIG. 21A, the flexible board 32 includes a front soldering section FE′, a rear soldering section RE′, and a circuit section CE′. The front soldering section FE′ is electrically connected to the rear soldering section RE′ through the circuit section CE′. The light sources LD are electrically connected to the circuit section CE′, and the projections of the light sources LD on the flexible board 32 are located within the circuit section CE′. Each of the sub protective layers 32222 of the first protective layer 3222 is separated from the front soldering section FE′ by a predetermined distance (as set forth above, the predetermined distance may be greater than 4 m). Similarly, each of the sub protective layers 32222 of the first protective layer 3222 is also separated from the rear soldering section RE′ by the predetermined distance.

The front soldering section FE′ includes a plurality of connection points, which may include a positive electrode, a negative electrode, a grounding point, etc. The rear soldering section RE′ also has the same structure. The circuit section CE′ includes a plurality of traces. The light sources LD are electrically connected to the traces, such that the light sources LD are electrically connected to the front soldering section FE′ and the rear soldering section RE′ through the traces.

The embodiment just exemplifies the disclosure and is not intended to limit the scope of the disclosure; any equivalent modification and variation according to the spirit of the disclosure is to be also included within the scope of the following claims and their equivalents.

Please refer to FIG. 21B, which is a fourth schematic view of the flexible board of the LED lighting device in accordance with the ninth embodiment of the disclosure. As shown in FIG. 21B, the flexible board 32 is disposed in the light cover 11, and the light sources LD are disposed within the circuit section CE′, thereby forming a light-emitting zone LZ′ (the light-emitting zone LZ′ is shown in FIG. 21B by one-point chain line; the light-emitting zone LZ′ stands for the zone which can emit light).

The light-emitting zone LZ′ can emit light, and the light can spread over the inner space of the light cover 11 to make the inner space of the light cover 11 form an optical zone XZ′ (the optical zone XZ′ is shown in FIG. 21B by two-point chain line; the optical zone XZ′ stands for the zone inside the light cover 11 filled with light). The optical section XZ′ simultaneously covers the light-emitting section LZ′, the front soldering section FE′ and the rear soldering section RE′.

Via the above optical structure design, the optical zone XZ′ of the light cover 11 can be further extended to cover the front soldering section FE′ and the rear soldering section RE′ of the flexible board 32 (the power supplier 14 is still outside the optical zone XZ′), which can further expand the optical zone XZ′ of the light cover 11. Thus, the overall light-emitting area of the LED lighting device 1 can be significantly increased, so the light efficiency of the LED lighting device 1 can be enhanced.

In addition, the surface of the light cover 11 is enclosed by an optical film. The optical film includes a transparent portion and a non-transparent portion. The distance between the non-transparent portion and the flexible board 32 is less than the distance between the transparent portion and the flexible board 32, such that the transparent portion faces the light sources LD. The area of the non-transparent portion is greater than or at least equal to the area of the flexible board 32, allowing the non-transparent portion to conceal(cover) the rear surface of the flexible board 32. The light sources LD are disposed on the front surface of the flexible board 32. The structure of the optical film is the same as that shown in FIG. 12, and thus will not be described in further detail herein.

The embodiment just exemplifies the disclosure and is not intended to limit the scope of the disclosure; any equivalent modification and variation according to the spirit of the disclosure is to be also included within the scope of the following claims and their equivalents.

The disclosure further provides a high-compatibility direct-current light source board, which includes a board body, a first direct-current conductor, a second direct-current conductor, a first light source conductor, a second light source conductor, and a plurality of light-emitting units. The first direct-current conductor is disposed on the board body and is connected to the positive electrode of the rectifying circuit of a driving power source. The second direct-current conductor is disposed on the board body and is connected to the negative electrode of the rectifying circuit. The first light source conductor is disposed on the board body and is connected to the positive electrode of the constant-current circuit of the driving power source. The second light source conductor is disposed on the board body and is connected to the negative electrode of the constant-current circuit of the driving power source. The light-emitting units are disposed on the board body and are connected to the first light source conductor and the second light source conductor.

In one embodiment, the first light source conductor and the second light source conductor are disposed between the first direct-current conductor and the second direct-current conductor.

In one embodiment, the first direct-current conductor has a first recess. The first recess extends in the direction away from the central line of the board body.

In one embodiment, the second direct-current conductor has a second recess. The second recess extends in the direction away from the central line of the board body.

In one embodiment, the first light source conductor has a first protruding portion. The first protruding portion extends in the direction away from the central line of the board body.

In one embodiment, the second light source conductor has a second protruding portion. The second protruding portion extends in the direction away from the central line of the board body.

In one embodiment, a plurality of isolation regions are provided between the first light source conductor and the second light source conductor. The isolation regions are distributed on the two sides of the light-emitting units.

In one embodiment, the board body is a flexible board or a rigid board.

In one embodiment, the light-emitting units are light-emitting diodes (LEDs).

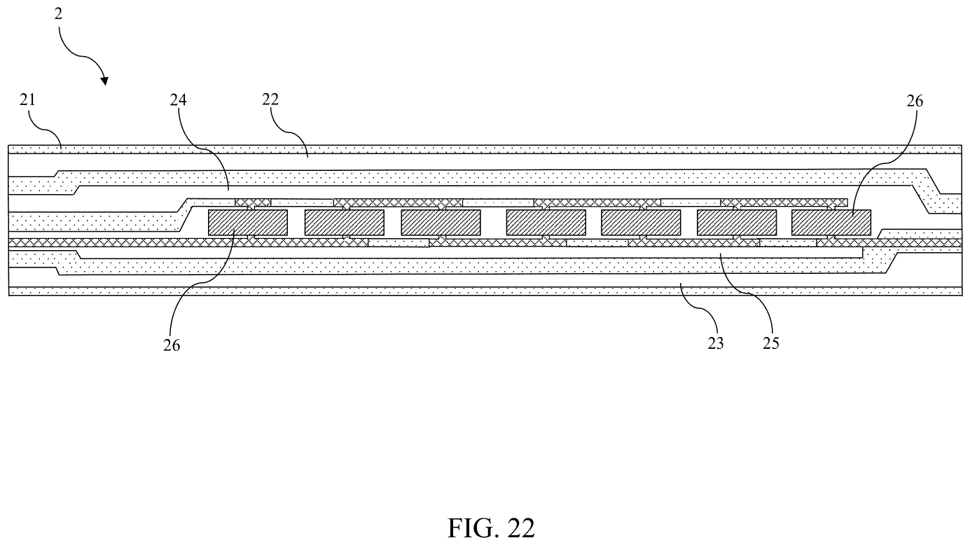

Please refer to FIG. 22, which is a first schematic view of a structure of a high-compatibility direct-current light source board in accordance with a tenth embodiment of the disclosure. The high-compatibility direct-current light source board 2 can be applied to a light-emitting diode lighting device. The light-emitting diode lighting device may include a driving power source and a direct-current light source board 2. As shown in FIG. 22, the direct-current light source board 2 includes a board body 21, a first direct-current conductor 22, a second direct-current conductor 23, a first light source conductor 24, a second light source conductor 25, and a plurality of light-emitting units 26.

The first direct-current conductor 22 is disposed on the board body 21 and is connected to the positive electrode of the rectifying circuit of the driving power source. One end of the first direct-current conductor 22 may be connected to the positive output terminal of the rectifying circuit of the driving power source, while the other end may be connected to the positive input terminal of the rectifying circuit. In one embodiment, the board body 21 may be a rigid board (PCB). In another embodiment, the board body 21 may be a flexible board (FPCB).

The second direct-current conductor 23 is disposed on the board body 21 and is connected to the negative electrode of the rectifying circuit. One end of the second direct-current conductor 23 may be connected to the negative output terminal of the rectifying circuit of the driving power source, while the other end may be connected to the negative input terminal of the rectifying circuit.

The first light source conductor 24 is disposed on the board body 21 and is connected to the positive electrode of the constant-current circuit of the driving power source. The first light source conductor 24 is disposed between the first direct-current conductor 22 and the second direct-current conductor 23.

The second light source conductor 25 is disposed on the board body 21 and is connected to the negative electrode of the constant-current circuit of the driving power source. The second light source conductor 25 is disposed between the first direct-current conductor 22 and the second direct-current conductor 23, and is adjacent to the first light source conductor 24. The first direct-current conductor 22, the second direct-current conductor 23, the first light source conductor 24, and the second light source conductor 25 may each be copper-clad conductors or other metal conductors.

The light-emitting units 26 are disposed on the board body 21 and are electrically connected to the first light source conductor 24 and the second light source conductor 25. The light-emitting units 26 may be light-emitting diodes (LEDs).

As previously stated, the direct-current light source board 2 includes the board body 21, the first direct-current conductor 22, the second direct-current conductor 23, the first light source conductor 24, the second light source conductor 25, and the light-emitting units 26. The first direct-current conductor 22 and the second direct-current conductor 23 are connected to the rectifying circuit of the driving power source, while the first light source conductor 24 and the second light source conductor 25 are connected to the constant-current circuit of the driving power source. Accordingly, the direct-current light source board 2 can be compatible with electronic ballasts. In addition, the first direct-current conductor 22, the second direct-current conductor 23, the first light source conductor 24, and the second light source conductor 25 carry direct-current signals. Therefore, when the direct-current light source board 2 is interrupted or scratched for any reason, the board 2 can effectively transform from a complete conductor into two equivalent capacitors. These two equivalent capacitors, when fully charged, block the direct-current signal to prevent fire hazards caused by temperature rise. Therefore, the safety of the direct-current light source board 2 can be effectively enhanced without increasing its cost.

By contrast, for currently available light source boards, when a circuit is broken or scratched, the alternating-current signal passes through the copper-clad conductor, transforming a previously complete conductor into two electrodes with AC voltage. Due to the inherent capacitance effect of the AC signal, the break in the copper-clad conductor forms two electrodes separated by a gap, creating an equivalent standard capacitor. The AC signal can flow through the two electrodes, and the current is determined by the capacitive reactance, which can be expressed be Equation (1) given below:

$$X c = 1 / ( 2 π fC ▯ \qquad ( 1 )$$

In Equation (1), Xc stands for the capacitive reactance, f stands for the frequency of the AC signal, and C stands for the capacitance of the capacitor.

From Equation (1), the capacitive reactance is inversely proportional to the AC signal frequency and the capacitor's capacitance. During coupling, the capacitance formed between the electrodes initially exhibits low breakdown voltage. When the voltage across the electrodes is sufficiently high, visible arcing occurs. As the arcing continues, the material in the electrode gap is carbonized, filling the original gap and increasing the equivalent capacitance. According to Equation (1), if the AC frequency remains constant, a larger capacitance results in a lower reactance, increasing the current through the equivalent capacitor. Consequently, the temperature between the electrodes continues to rise, further accelerating the carbonization reaction. This creates a positive feedback loop until the electrodes are sufficiently separated, the breakdown voltage of the equivalent capacitor increases, the capacitance gradually decreases, and the current decreases, reducing heat generation. The loop continues until no visible flame occurs or the substrate glass fails due to high temperature, thereby interrupting the positive feedback process.

In this embodiment, however, the first direct-current conductor 22, the second direct-current conductor 23, the first light source conductor 24, and the second light source conductor 25 carry direct-current signals. When interrupted or scratched, the direct-current light source board 2 transforms from a complete conductor into two equivalent capacitors formed by two electrodes carrying direct-current signals. These capacitors, once fully charged, block the DC signal to prevent fire hazards due to overheating. Therefore, the safety of the direct-current light source board 2 can be effectively improved without increasing its cost.

The embodiment just exemplifies the disclosure and is not intended to limit the scope of the disclosure; any equivalent modification and variation according to the spirit of the disclosure is to be also included within the scope of the following claims and their equivalents.

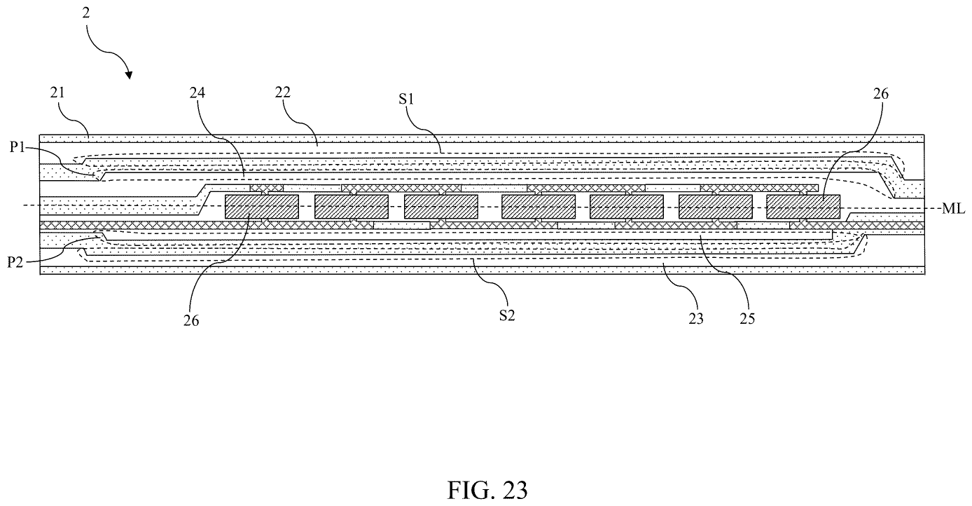

Please refer to FIG. 23, which is a second schematic view of the structure of the high-compatibility direct-current light source board in accordance with the tenth embodiment of the disclosure. As shown in FIG. 23, the first direct-current conductor 22 includes a first recess S1 extending away from the central line ML of the board body 21. The second direct-current conductor 23 includes a second recess S2 extending away from the central line ML. The first light source conductor 24 includes a first protruding portion P1 extending away from the central line ML. The second light source conductor 25 includes a second protruding portion P2 extending away from the central line ML.

The special conductor structure design can optimize the capacitance effect and effectively destroy the continuity of scratches to prevent sparks. Accordingly, the safety of the direct-current light source board 2 can be further enhanced.

The embodiment just exemplifies the disclosure and is not intended to limit the scope of the disclosure; any equivalent modification and variation according to the spirit of the disclosure is to be also included within the scope of the following claims and their equivalents.

In another embodiment, a plurality of isolation regions are disposed between the first light source conductor 24 and the second light source conductor 25.

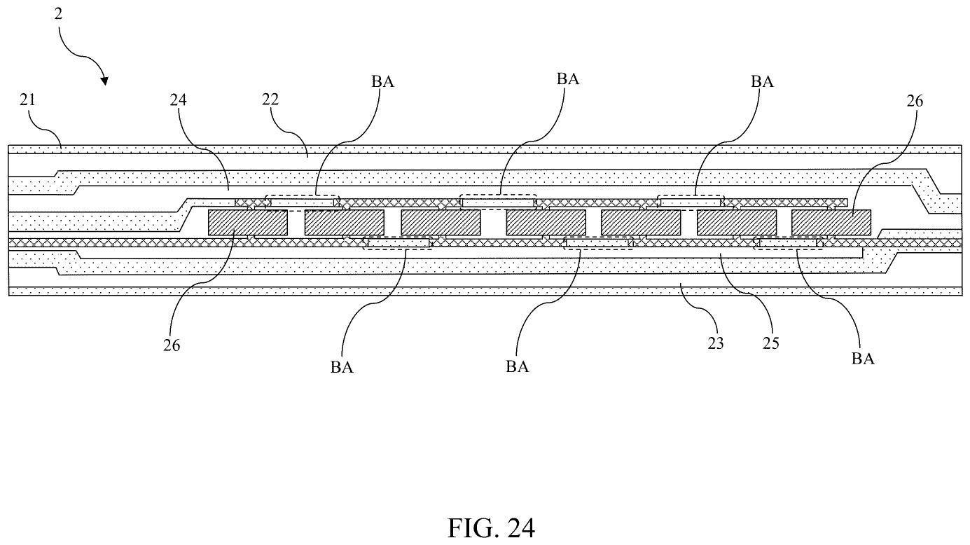

Please refer to FIG. 24, which is a third schematic view of the structure of the high-compatibility direct-current light source board in accordance with the tenth embodiment of the disclosure. As shown in FIG. 24, the isolation regions BA are disposed between the first light source conductor 24 and the second light source conductor 25. These isolation regions BA are arranged on the two sides of the light-emitting units 26.

From the foregoing, in this embodiment, the first light source conductor 24 and the second light source conductor 25 are separated by multiple isolation regions BA arranged on the two sides of the light-emitting units 26. The special isolation region structure can provide a barrier effect to reduce the impact of a break or scratch on the light-emitting units 26 and increase the impedance of surrounding conductors during abnormal conditions. Additionally, the isolation regions BA can make scratches discontinuous, preventing sparks and enhancing the blocking effect on the DC signal. Therefore, the safety of the direct-current light source board 2 can be further improved.

Most currently available light source boards in lighting devices use printed circuit boards (PCBs) or flexible printed circuit boards (FPCBs), where AC signals flow. Conductors (copper-clad traces) on such boards are prone to breaks or scratches, which can generate sparks and lead to fires. To address this, some lighting devices adopt flame-retardant metal PCBs or double-sided metal FPCBs. While these boards mitigate the problem to some extent, they substantially increase costs. The high-compatibility direct-current light source board disclosed in the embodiments of the disclosure effectively solves these issues.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the disclosure, the direct-current light source board includes a board body, a first direct-current conductor, a second direct-current conductor, a first light source conductor, a second light source conductor, and a plurality of light-emitting units. The first direct-current conductor is disposed on the board body and is connected to the positive electrode of the rectifying circuit of a driving power source. The second direct-current conductor is disposed on the board body and is connected to the negative electrode of the rectifying circuit. The first light source conductor is disposed on the board body and is connected to the positive electrode of the constant-current circuit of the driving power source. The second light source conductor is disposed on the board body and is connected to the negative electrode of the constant-current circuit of the driving power source. The light-emitting units are disposed on the board body, and are connected to the first light source conductor and the second light source conductor. As described above, the first direct-current conductor, the second direct-current conductor, the first light source conductor, and the second light source conductor of the direct-current light source board all carry direct-current signals. Therefore, when the direct-current light source board is interrupted or scratched for any reason, the board can effectively transform from a complete conductor into two electrodes carrying direct-current signals, forming two equivalent capacitors. These two equivalent capacitors, when fully charged, block the direct-current signal to prevent fire hazards caused by temperature rise. Accordingly, the safety of the direct-current light source board can be effectively enhanced without increasing its cost. In addition, the direct-current light source board is compatible with electronic ballasts.

Also, according to one embodiment of the disclosure, the first light source conductor and the second light source conductor are disposed between the first direct-current conductor and the second direct-current conductor. The first direct-current conductor includes a first recess, and the first recess extends in the direction away from the central line of the board body. The second direct-current conductor includes a second recess, and the second recess extends in the direction away from the central line of the board body. The first light source conductor includes a first protruding portion, and the first protruding portion extends in the direction away from the central line of the board body. The second light source conductor includes a second protruding portion, and the second protruding portion extends in the direction away from the central line of the board body. This special conductor structure design can optimize the capacitance effect and effectively disrupt the continuity of scratches to prevent sparks. Therefore, the safety of the direct-current light source board can be further enhanced.

Further, according to one embodiment of the disclosure, a plurality of isolation regions are disposed between the first light source conductor and the second light source conductor, and these isolation regions are arranged on the two sides of the light-emitting units. This special isolation region structure can provide a certain blocking effect, reducing the impact on the light-emitting units when a break or scratch occurs, and enhancing the impedance of surrounding conductors under abnormal conditions. Moreover, this special isolation region structure can make scratches discontinuous to prevent sparks and improve the blocking of the direct-current signal. Therefore, the safety of the direct-current light source board can be further enhanced.

Moreover, according to one embodiment of the disclosure, the board body of the direct-current light source board may be a flexible board (FPCB) or a rigid board (PCB). Therefore, the user can select a suitable material based on actual requirements. Accordingly, the direct-current light source board can be applied to various lighting devices, providing greater flexibility in use and wider applicability.

Furthermore, according to one embodiment of the disclosure, the direct-current light source board has a simple design, enabling the desired effect to be achieved without increasing cost. In addition, the direct-current light source board can achieve high compatibility (compatible with electronic ballasts). Therefore, the direct-current light source board is highly practical and can meet the requirements of different applications.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A light-emitting diode (LED) lighting device, comprising:
a power supplier;
a flexible board electrically connected to the power supplier, and comprising a substrate and a laminated structure, wherein the laminated structure is disposed on a first surface of the substrate and comprising a transparent ink layer and a first protective layer, and the transparent ink layer is disposed on the first protective layer; and
a plurality of light sources disposed on the laminated structure and electrically connected to the flexible board.

2. The LED lighting device as claimed in claim 1, wherein the first protective layer is an ink layer.

3. The LED lighting device as claimed in claim 1, wherein the first protective layer is a cover film, and the cover film comprises a bottom plate, a first adhesive layer, and an ink layer, wherein the first adhesive layer is disposed on the bottom plate, and the ink layer is disposed on the first adhesive layer.

4. The LED lighting device as claimed in claim 1, further comprising a reinforcing structure disposed on a second surface of the substrate.

5. The LED lighting device as claimed in claim 4, wherein the reinforcing structure partially covers the second surface of the substrate.

6. The LED lighting device as claimed in claim 4, wherein the reinforcing structure includes a backing adhesive disposed on the second surface of the substrate.

7. The LED lighting device as claimed in claim 4, wherein the reinforcing structure comprises a backing adhesive, a second protective layer, and a second adhesive layer, wherein the backing adhesive is disposed on the second protective layer, the second protective layer is disposed on the second adhesive layer, and the second adhesive layer is disposed on the second surface of the substrate.

8. The LED lighting device as claimed in claim 7, wherein the second protective layer is an ink layer.

9. The LED lighting device as claimed in claim 1, wherein the first protective layer comprises an opening and two sub protection layers, and the sub protective layer are disposed on two sides of the opening respectively.

10. The LED lighting device as claimed in claim 9, wherein the opening comprises a front section, a rear section and a connecting section, and the front section is connected to the rear section via the connecting section, and the sub protective layers are disposed on two sides of the connecting section respectively.

11. The LED lighting device as claimed in claim 10, wherein a projection of any one of the light sources on the first protective layer is located within the connecting section.

12. The LED lighting device as claimed in claim 10, further comprising two end caps and a light cover, wherein the flexible board is disposed in the light cover, and the two end caps are disposed at two ends of the light cover respectively, and the power supplier is disposed in one of the end caps.

13. The LED lighting device as claimed in claim 10, wherein a surface of the light cover is enclosed by an optical film comprising a transparent portion and a non-transparent portion, and the non-transparent portion is adjacent to the circuit board, whereby a rear surface of the flexible board is covered by the non-transparent portion.

14. The LED lighting device as claimed in claim 12, wherein the flexible board comprises a front soldering section, a rear soldering section and a circuit section, wherein the front soldering section is electrically connected to the rear soldering section via the circuit section, and the front soldering section and the rear soldering section are electrically connected to the power supplier, wherein the light sources are electrically connected to the circuit section, and projections of the light sources on the flexible board are located within the connecting section.

15. The LED lighting device as claimed in claim 14, wherein the light sources are within the connecting section to serve as a light-emitting zone, and the light-emitting zone makes an inner space of the light cover forms an optical zone, whereby the optical zone simultaneously covers the light-emitting zone, the front soldering section and the rear soldering section.

16. The LED lighting device as claimed in claim 10, wherein the front section is connected to the rear section via the connecting section, whereby the opening is H-shaped.

17. The LED lighting device as claimed in claim 10, wherein the connecting section comprises a plurality of bending portions and a plurality of connecting portions connected to each other, and the bending portions and the connecting portions are arranged in an alternating order.

18. The LED lighting device as claimed in claim 17, wherein a shape of the bending portion is U-shaped or inverted U-shaped.

19. The LED lighting device as claimed in claim 17, wherein each of the bending portions comprises at least one vertical portion and a horizontal portion connected to each other and perpendicular to each other, and a width of the horizontal portion is greater than a width of the connecting portion.
